(19) United States
(12) Patent Application Publication
(10) Pub. No.: US 2026/0077260 A1
(43) Pub. Date: Mar. 19, 2026

(54) OBJECT PREDICTING APPARATUS

(71) Applicant: Gizmo and Trinket LLC, Broadview Heights, OH (US)

(72) Inventors: Jeffrey Cochran, Broadview Heights, OH (US); Jane Ferris, East Amherst, NY (US); Benjamin Charley, Broadview Heights, OH (US); Andrew Seme, Broadview Heights, OH (US)

(73) Assignee: Gizmo and Trinket LLC, Broadview Heights, OH (US)

(21) Appl. No.: 19/327,417

(22) Filed: Sep. 12, 2025

Related U.S. Application Data
(60) Provisional application No. 63/694,288, filed on Sep. 13, 2024.

(51) Int. Cl. A63F 9/04; G06T 7/215; G06T 7/73; H04N 23/56

(52) U.S. Cl. CPC A63F 9/0406; G06T 7/215; G06T 7/73; H04N 23/56

(57) ABSTRACT

A rollable object outcome reader comprises a rolling surface that supports on a first side one or more rollable objects each including a plurality of surfaces that each include a respective face indicator and an image capture device configured to capture an image of a second side opposite the first side. The outcome reader includes a control system that receives the captured image and determines an orientation of a rollable object on the first side of the rolling surface based on the captured image by determining a first face indicator of a first surface of the rollable object resting on and directly facing the first side of the rolling surface and determining a second face indicator of a second surface of the rollable object opposite the first surface based on the determined first face indicator of the first surface based on a predetermined relationship for the rollable object.

### FIELD OF THE INVENTION

The present application relates generally to a system and method for determining an upper facing surface of a rollable object based on determining a downward facing surface of the rollable object.

### BACKGROUND

As part of the broader entertainment industry in the U.S., approximately 213 million engage in video-based gaming, and another 70 million regularly play board games. Accordingly, approximately 82% of the U.S. population participates in some form of gameplay. Because games both shape and encourage socializing, education, and competition, the game industry represents significant opportunity within the national economy.

The far-reaching effects of the COVID-19 pandemic enveloped many economic sectors, broadly including the multi-facets of the entertainment industry. In particular, the wide-spread lockdowns and emphasis on social-distancing challenged the social fabric of the game-playing industry. Despite the inability to congregate publicly, the already large number of game-players increased as a response to more available free time and boredom. Moreover, a significant subset of role-playing individuals improvised new ways to feed their passion remotely as a means to overcome their isolation while maintaining the authentic, interactive nature of role-playing games.

Of the 280+ million individuals that play some form of game, a substantial number specifically participate in dice-driven games. Around these dice-driven games a second, expensive hobby has emerged, namely, collecting dice. Financially invested in their dice collections, players are both excited and adamant about using their own dice for the games they play. For such collectors, the migration to online gaming deprived them of their ability to use their dice collection in actual games. Several organizations developed wireless-enabled dice that could be coupled to online games. Although superficially interesting if not attractive, the wireless-enabled dice amount to nothing more than another set of dice in the collection, rather than a means by which to leverage the entire collection.

### SUMMARY OF INVENTION

Accordingly, there is a need for an apparatus, system, and/or method that provides a new die reading apparatus utilized in games.

Therefore, the following rollable object classification system described herein is adaptable to different types of rollable objects without requiring a user to either modify existing dice or only use set dice. As described in detail below, the rollable object classification system is configured to capture an image of a bottom side of a die and then employs a die map, formula, or the like to determine a face indicator on a non-captured face of the die.

According to an aspect of the disclosure, a rollable object outcome reader comprises a rolling surface that supports on a first side of the rolling surface one or more rollable objects each including a plurality of surfaces that each include a respective face indicator; an image capture device configured to capture an image of a second side of the rolling surface opposite the first side; and a control system configured to: receive the captured image from the image capture device; determine an orientation of a rollable object on the first side of the rolling surface based on the captured image, wherein determining the orientation includes determining a first face indicator of a first surface of the rollable object resting on and directly facing the first side of the rolling surface; and determine a second face indicator of a second surface of the rollable object opposite the first surface based on the determined first face indicator of the first surface, wherein determining the second face indicator is based on a predetermined relationship for the rollable object.

According to an embodiment of any paragraph(s) of this summary, the rolling surface is translucent.

According to an embodiment of any paragraph(s) of this summary, the image capture device comprises a camera.

According to an embodiment of any paragraph(s) of this summary, further comprising a light source positioned to illuminate the second side of the rolling surface.

According to an embodiment of any paragraph(s) of this summary, further comprising a light cone positioned to reflect light from the light source toward the second side of the rolling surface.

According to an embodiment of any paragraph(s) of this summary, further comprising a reflective surface arranged to reflect the second side of the rolling surface, wherein a lens of the image capture device is positioned to capture the image of the second side of the rolling surface by capturing an image of the reflective surface.

According to an embodiment of any paragraph(s) of this summary, the reflective surface extends parallel to the second side of the rolling surface.

According to an embodiment of any paragraph(s) of this summary, the lens of the image capture device is positioned perpendicular to the rolling surface.

According to an embodiment of any paragraph(s) of this summary, the control system is further configured to: generate a bounding box around the rollable object that moves with the rollable object; and determine movement of the rollable object by detecting movement of the bounding box.

According to an embodiment of any paragraph(s) of this summary, the control system is further configured to operate the image capture device to capture the image after detecting that the bounding box remains stationary for a predefined threshold of time.

According to an embodiment of any paragraph(s) of this summary, further comprising a housing, wherein the rolling surface and the image capture device are retained in the housing such that the image capture device is a fixed distance from the rolling surface.

According to an embodiment of any paragraph(s) of this summary, further comprising: a light source positioned to illuminate the second side of the rolling surface; and a light cone positioned to reflect light from the light source toward the second side of the rolling surface, wherein the light source and the light cone are arranged in the housing between the rolling surface and the image capture device.

According to an embodiment of any paragraph(s) of this summary, the light cone includes threads that engage corresponding housing threads to attach the light cone to the housing.

According to an embodiment of any paragraph(s) of this summary, the control system is further configured to: determine a second orientation of a second rollable object on the first side of the rolling surface based on the captured image, wherein determining the second orientation includes determining a third face indicator of a third surface of the second rollable object resting on and directly facing the first side of the rolling surface; and determine a fourth face indicator of a fourth surface of the second rollable object opposite the third surface based on the determined third face indicator of the third surface, wherein determining the fourth face indicator is based on a predetermined relationship for the second rolling object.

According to another aspect of the disclosure, a method of determining an outcome of rolling a rollable object comprises capturing an image of a second side of a rolling surface opposite a first side of the rolling surface that supports the rollable object, wherein the rollable object includes a plurality of surfaces that each include a respective face indicator; determining an orientation of a rollable object on the first side of the rolling surface based on the captured image by determining a first face indicator of a first surface of the rollable object resting on and directly facing the first side of the rolling surface; and determining a second face indicator of a second surface of the rollable object opposite the first surface based on the determined first face indicator of the first surface and a predetermined relationship for the rolling object.

According to an embodiment of any paragraph(s) of this summary, the step of capturing the image includes: generating a bounding box around the rollable object that moves with the rollable object; determining movement of the rollable object by detecting movement of the bounding box; and capturing the image after detecting that the bounding box remains stationary for a predefined threshold of time.

According to an embodiment of any paragraph(s) of this summary, further comprising detecting that the rollable object has been removed from the rolling surface; and detecting that a second rollable object is placed on the first side of the rolling surface

According to an embodiment of any paragraph(s) of this summary, further comprising capturing a second image of the second side of the rolling surface after detecting that the second rollable object is placed on the first side of the rolling surface after detecting an absence of a rollable object for a threshold period of time.

According to a further aspect of the disclosure, a non-transitory computer-readable medium storing instructions that, when executed by a control system of a rollable object outcome reader, cause the control system to receive an image captured by an image capture device of a second side of a rolling surface while one or more rollable objects are supported on a first side of the rolling surface, wherein the first side is opposite the second side; determine an orientation of a rollable object on the first side of the rolling surface based on the captured image, wherein determining the orientation includes determining a first face indicator of a first surface of the rollable object resting on and directly facing the first side of the rolling surface; and determine a second face indicator of a second surface of the rollable object opposite the first surface based on the determined first face indicator of the first surface, wherein determining the second face indicator is based on a predetermined relationship for the rolling object.

### BRIEF DESCRIPTION OF THE DRAWINGS

FIG. 1 illustrates a functional block diagram of rollable object determination system according to an embodiment of the disclosure.

FIG. 2 illustrates a perspective view of a rolling area component according another embodiment of the disclosure.

FIG. 3 illustrates a bottom perspective view of the rolling area component of FIG. 2.

FIG. 4 illustrates an exploded view of the rolling area component of FIG. 2.

FIG. 5 illustrates a cross-sectional profile view of the rolling area component of FIG. 2.

FIG. 6 illustrates a cross-sectional profile view of a portion of a rolling area component according to another embodiment of the disclosure.

FIG. 7 illustrates a cross-sectional profile view of a portion of a rolling area component according to a further embodiment of the disclosure.

FIG. 8 illustrates a die map according to an embodiment of the disclosure.

FIGS. 9-13 illustrate a plurality of images captured by an object detection system of a bottom side of a rolling surface according to an embodiment of the disclosure.

FIG. 14 illustrates a view of a first side of the rolling surface illustrated in FIG. 12.

FIGS. 15-17 illustrate different embodiments of visual representations displayed on a user device according to embodiments of the disclosure.

### DETAILED DESCRIPTION

The rollable object determination system described herein is configured to determine a face indicator of a first face of a rollable object based on determining a second face indicator of a second face of the rollable object. As will be described in detail below, the rollable object determination system is configured to capture an image of a second side of the rolling surface while the rollable object rests on an opposing first side of the rolling surface. The rollable object determination system then uses a face indicator on the captured bottom face of the rollable object in the captured image in combination with an object faces map or formula to determine face indicators of other faces of the rollable object. By using a rollable-object specific model to determine the different non-captured faces of the rollable object, the rollable object determination system is adaptable for a plurality of different rollable objects, including custom rollable objects.

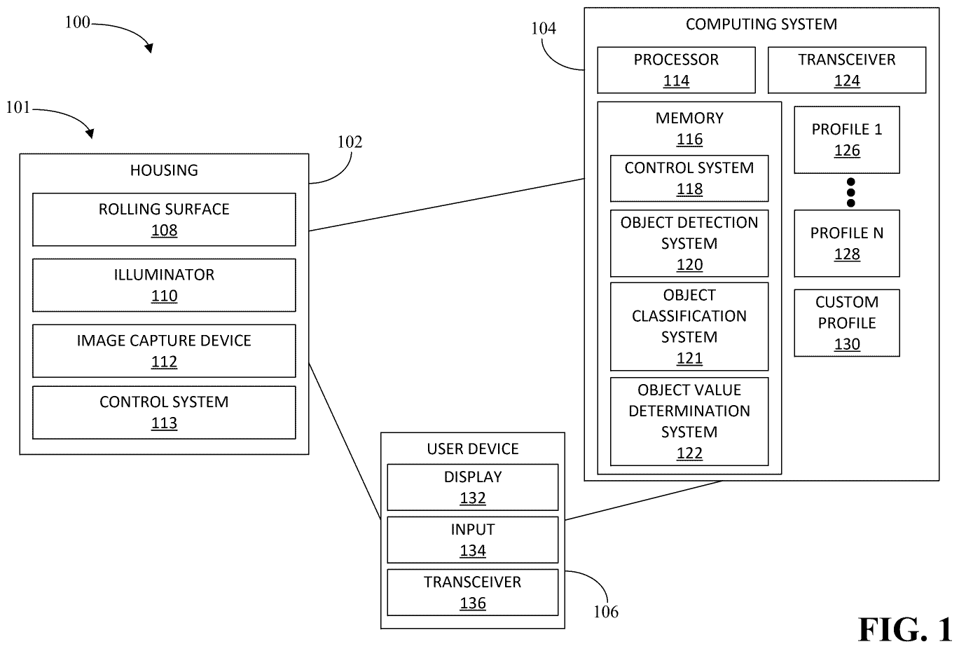

Turning to FIG. 1, an object determination system 100 includes a rolling area component 101 with a housing 102 including a rolling surface 108, a computing system 104 configured to determine a face indicator on a first face of a rollable object on the rolling surface based on a face indicator on a second surface of the rollable object, and a user device 106 configured to display information regarding the determined face indicator on a display 132 of the user device 106. The housing 102 may have any suitable shape, size, or the like and the dimensions of the housing 102 may vary for different types of rollable objects or different uses. Similarly, the shape or configuration of the rolling surface 108 may be a function of the type of rollable object or use of the object determination system 100.

As will be described in detail below, the object determination system 100 is configured to determine a face indicator on a first face of the rollable object on the rolling surface 108 and using the determined face indicator of the first face to determine a second face indicator on a second face of the rollable object. To that end, the rolling area component 101 further includes an illuminator 110 that illuminates the rolling surface 108 and an image capture device 112 configured to capture one or more images of the illuminated rolling surface 108. The image capture device 112 can be configured to capture images of any suitable face of the rollable object and the embodiments described herein, the image capture device 112 is positioned to capture image(s) of a face of the rollable object resting on a first side of the rolling surface 108, e.g., a downward facing surface of the rollable object. In other words, the image capture device 112 is positioned to capture one or more images of a second side (e.g., a bottom surface) of the rolling surface 108 opposite the first side of the rolling surface 108 while the one or more rollable objects are arranged on the first side (e.g., a top surface) of the rolling surface 108 opposite the bottom surface. In the embodiments described herein, the illuminator 110 illuminates a bottom surface or area of the rolling surface 108.

To permit the image capture device 112 to capture an image of a downward facing surface of the rollable object, the rolling surface 108 may include at least a portion that permits light to pass through the rolling surface 108. For instance, the portion of the rolling surface 108 may be transparent, translucent, or the like. Additionally, or alternatively, the bottom surface or the top surface of the rolling surface 108 may include one or more coatings that may blur irrelevant background features in images captured by the image capture device 112, reduce background light intensity, reduce specular reflection from the illuminator 110, or a combination thereof.

The image capture device 112 is configured to capture one or more images of the illuminated bottom surface of the rolling surface 108 and, by extension, the downward facing face of the rollable object through the rolling surface 108. In one embodiment, the image capture device 112 is configured to capture an image only after detection that a rollable object has stopped rolling, e.g., movement on the top surface of the rolling surface 108. In another embodiment, the image capture device 112 is configured to capture images at predefined intervals. In a further embodiment, the image capture device is configured to capture a continuous video of the bottom surface of the rolling surface 108.

Any suitable image capture device 112 for capturing one or more images of the bottom surface of the rolling surface 108 is envisioned. For instance, the image capture device 112 may comprise a camera (e.g., a digital camera), a LiDAR image capture device, an infrared image capture device, or the like.

To operate the illuminator 110 and the image capture device 112, the rolling area component 101 further includes a control system 113.

To determine the face indicator on the downward facing face of the rollable object, the object determination system 100 includes the computing system 104 that receives the one or more captured images from the image capture device 112. In the embodiment illustrated in FIG. 1, the computing system 104 is illustrated as a separate component and the rolling area component 101, the user device 106, or both are in communication with the computing system 104. In one example, only the user device 106 is in communication with the computing system 104 and the rolling area component 101 first transmits the captured images to the user device 106, which in turn transmits the captured images to the external computing system 104. In another example, the rolling area component 101 is configured to directly transmit the captured images to the external computing system 104. The captured images may be transmitted by any suitable method, such as a wireless connection (e.g., infrared (IR) wireless communication, broadcast radio, microwave radio, Bluetooth, Wi-Fi, etc.) or a wired connection (e.g., the user device 106 is connected to the rolling area component 101 via a USB-C connection for data transfer therebetween). In yet another embodiment, the computing system 104 may be incorporated into the rolling area component 101 and/or the user device 106.

The computing system 104 includes a processor 114 and memory 116 that includes computer-executable instructions that are executed by the processor 114. In an example, the processor 114 can be or include a graphics processing unit (GPU), a plurality of GPUs, a central processing unit (CPU), a plurality of CPUs, an application-specific integrated circuit (ASIC), a microcontroller, or the like.

To receive information from the components in the rolling area component 101 and/or the user device 106 and to transmit information to the components, the computing system 104 may further include a transceiver 124. The transceiver 124 may be configured to transmit data from the computing system 104 and/or receive data at the computing system 104. The user device 106 may further include a corresponding transceiver 136 to transmit data from the user device 106 and/or receive data at the user device 106. Similarly, the rolling area component 101 may further include a corresponding transceiver (not pictured) to transmit data from the rolling area component 101 to the computing system 104 and/or the user device 106, and/or receive data at the rolling area component 101 from the computing system 104 and/or the user device 106.

The memory 116 may include a control system 118 configured to control operation of the rolling area component 101 to operate the illuminator 110 and/or capture images via the image capture device 112 based on detecting rolling (e.g., movement) of the rollable object. For instance, the control system 118 may interact with the corresponding control system 113 in the rolling area component 101. Additionally, or alternatively, the control system 118 is configured to control operation of the user device 106, as will be described in detail below.

For simplicity of explanation, the rollable object(s) described below comprises one or more dice. However, any type of object that may be rolled, cast, and/or thrown on the rolling surface 108 such that a resulting face indicator, pattern, arrangement, and/or meaning is interpretable is envisioned. For instance, other rollable objects include, for example and without limitation, runes, bones, tarot, coins, tiles, I Ching tokens, and/or the like.

The memory 116 further includes an object detection system 120 configured to determine when one or more dice are rolled on the rolling surface 108. That is, the object detection system 120 may be configured to detect movement of rollable objects, e.g., one or more dice, on the rolling surface 108. In the illustrated embodiment, the object detection system 120 is in the computing system 104 separate from the rolling area component 101. In another embodiment, the object detection system 120 is in the rolling area component 101 for operation by a respective processor. The object detection system 120 may be configured to generate a bounding box around a detected die when the die lands on the top surface of the rolling surface 108. Each die rolled on rolling surface 108 may have a respective bounding box and/or multiple dice may share a bounding box. As the die/dice roll across the rolling surface 108, the object detection system 120 tracks the bounding boxes associated with the rolling dice. The object detection system 120 may be further configured to measure a change of bounding box positions from one frame in a video (or in one image of a series of captured images) from the image capture device 112 to a subsequent frame in the video from the image capture device 112. To that end, the computing system 104 may include metadata comprising a set of parameters and/or hyperparameters for detecting the presence of the rollable objects and for generating the bounding boxes. For instance, the parameters and/or hyperparameters may include the weights and structure of a neural network, bounding box cross-sections, and/or the like. The set of parameters may be part of the profiles 126-128 described below and/or may be separate.

When the measured change of bounding box position is within a predefined threshold, the object detection system 120 may be configured to determine that the rolling has stopped and the most recent image from the image capture device 112 is prepared for the next step performed by an object classification system 121 that may employ a classification model to classify the die in the bounding box. In one embodiment, the object detection system 120 is configured to send the latest image from the image capture device 112 to the object classification system 121. In another embodiment, the object detection system 120 may be further configured to crop the captured image from the image capture device 112 to the one or more bounding boxes and the cropped image(s) is sent to the object classification system 121.

Specifically, the memory 116 includes the object classification system 121 configured to determine a type of each of one or more dice in a bounding box. In the following description, for simplicity of explanation, only one die is within a respective bounding box. However, as noted above, a bounding box may contain more than one die (or rollable object) and the following description is intended solely as one non-limiting example. The object classification system 121 may be configured to determine a type of die in the bounding box. As seen in FIG. 1, the computing system 104 includes a plurality of profiles, namely, a profile 1 126, . . . , and a profile N 128 (collectively referred to herein as profiles 126-128). Each of the profiles 126-128 may be associated with a different die type and/or a die may have multiple profiles. For instance, profile 1 126 may be associated with a first type of die (e.g., six-sided die) while profile N 128 may be associated with a second type of die (e.g., eight-sided die). In another embodiment, profile 1 126 and profile N 128 may be associated with the same type of die (e.g., six-sided die) but each die is associated with a different face indicators, as described in detail below.

The profiles 126-128 can include identifying information for the type of die associated with the respective profile. For instance, each profile may include a set of parameters for the type of die associated with the respective profile. The set of parameters may include any suitable data for classifying the type of die by the object classification system 121. For instance, the parameters may include the weights and structure of a neural network, color, cross-section (e.g., cross-section of a face of the die), shape of face indicators, and/or the like.

Responsive to receiving the image from the object detection system 120, the object classification system 121 may be configured to access the profiles 126-128 to determine which type of die is in the bounding box in the captured image. In one embodiment, the object classification system 121 is configured to autonomously determine the type of die by accessing all of the profiles 126-128 to determine the type of die in the bounding box. For example, the object classification system 121 may incorporate a machine learning algorithm to determine the type of die. In another embodiment, a user may enter an input indicating a type of die or the exact die the user is planning to roll and the object classification system 121 uses this input to select a profile for use in confirming the die in the bounding box.

When multiple dice are simultaneously rolled, the user may enter an input indicating the dice that the user is intending to roll. The object classification system 121 may create a dice pool including information for each die the user intends to roll. The created dice pool may include a respective profile for each die in the dice pool. The object classification system 121 may then use the specific group of profiles for determining which die is in a respective bounding box.

In a further embodiment, the object classification system 121 may employ a machine learning algorithm to predict or determine a type of die in the bounding box of the captured image based on one or more characteristics in the captured image. The machine learning algorithm may be trained on data sets comprising known die faces and corresponding captured images.

The memory 116 further includes an object value determination system 122 configured to determine a face indicator on a first face of the die based on a face indicator of a second face of the die visible in the bounding box of the captured image. For instance, the object value determination system 122 may employ a die specific model to determine the face indicator on the first face of the die. In particular, the object value determination system 122 is configured to determine a face indicator on the face (hereafter “captured image face”) of the die resting on the rolling surface 108 visible in the captured image. The object value determination system 122 is configured to then use the determined face indicator on the captured image face to determine a face indicator one or more faces of the die other than the captured image face.

For instance, in addition to the set of parameters for the type of die, each profile may include a set of parameters for classifying the face indicator in the captured image face and for determining other face indicators via the object value determination system 122. For instance, the parameters may include the weights and structure of a neural network, a die formula, a two-dimensional or three-dimensional die map, a face indicator correlation table, and/or the like.

In the following example, the object value determination system 122 is configured to determine a face indicator of a face of the die that is opposite the captured image face (hereafter, “top image face”). In one embodiment, the object value determination system 122 employs a formula to determine the face indicator of the top image face based on the face indicator of the captured image face. For instance, in a conventional six-sided die, opposing sides of the die add up to seven. Accordingly, when the object classification system 121 determines that the die in the bounding box is a conventional six-sided die, the object value determination system 122 subtracts the value of the face indicator on the captured image face from seven to determine the value of the face indicator on the top image face.

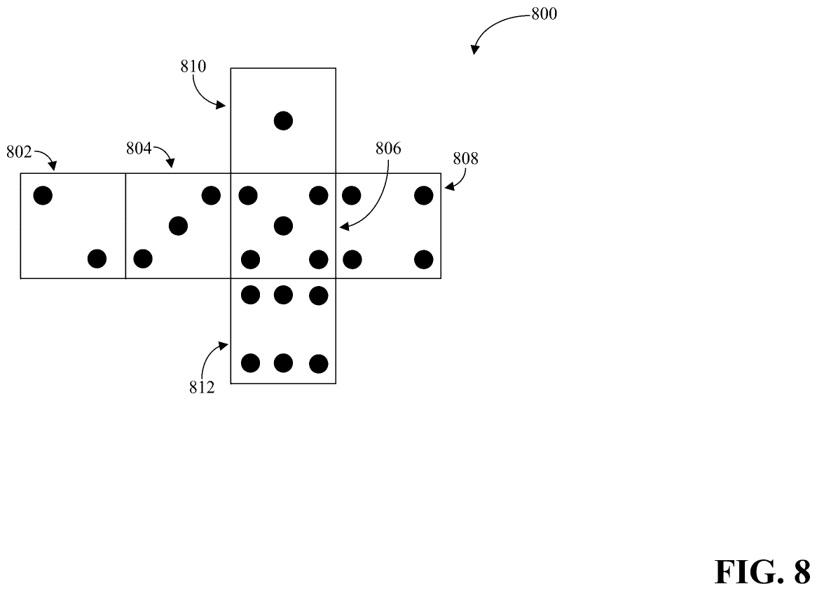

In another embodiment, the object value determination system 122 employs a predefined map to determine the face indicator of the top image face. As described below with respect to FIG. 8, the computing system 104 may store one or more predefined maps and one or more of the profiles 126-128 may be associated with a respective predefined map. For instance, profile 1 126 may additionally include a first predefined map associated with the first type of die while profile N 128 may additionally include a second predefined map associated with the second type of die. The predefined map may include information regarding the orientation of the different faces of the die relative to each other in a two-dimensional arrangement. Additionally, or alternatively, the predefined map may be a three-dimensional representation of the die.

Additionally, or alternatively, the object value determination system 122 may employ a machine learning algorithm to determine the face indicator of the top image face based on the face indicator of the captured image face instead of calculating the value of the face indicator or relying on a predefined map. The machine learning algorithm may be trained on known relationships between different opposing faces of a die and/or known die maps.

When multiple dice are rolled simultaneously, the above described actions performed by the computing system 104 may be performed for each die simultaneously, sequentially such that a face indicator of a first die is determined before a face indicator of a second die is determined, or the like.

In addition to the profiles 126-128 that include predefined set of parameters, a user may generate a custom profile 130 that may be used by the object classification system 121 and/or the object value determination system 122. For instance, the user may indicate, e.g., via an input 134 of the user device 106, a custom die type, e.g., number of faces, shape of the faces, color(s) of the die, shape of the face indicators, material of the die, an associated machine learning model and corresponding parameters, or the like. Additionally, or alternatively, the user may upload, e.g., via an input 134 of the user device 106, a custom map for a custom die not included in the predefined profiles 126-128. In another example, the user may cause the computing system 104 to generate a custom map by having the user sequentially roll the die while the image capture device 112 captures different faces of the custom die. In yet another example, the computing system 104 may generate a table for use by the object determination system 122 that expresses which face indicators are on opposite sides of the custom die.

The computing system 104 may be further configured to transmit data representative of the determined face indicator of the top image face to the user device 106 for display by the display 132 of the user device 106. The computing system 104 and/or the user device 106 may be configured to determine how the data will be displayed. For instance, the user may indicate that the roll of the die is for a specific purpose and the computing system 104 and/or the user device 106 may determine how the face indicator should be displayed based on the specific purpose. As an example, the user may indicate that multiple dice are being rolled at the same time and only the die with the highest value face indicator on the respective top image face should be displayed. As another example, the user may indicate that a sum of face indicator values for respective top image faces of multiple rolled dice should be displayed.

Any suitable user device 106 may be employed for the purpose of operating the computing system 104 and/or the rolling area component 101, displaying the data from the computing system 104, transmitting data from the rolling are component 102 to the computing system 104 and/or vice-versa, and/or the like. For example, the user device 106 may comprise a desktop computing device, a laptop computing device, a mobile telephone, a tablet computing device, a wearable computing device, or the like. In an embodiment, the user device 106 may include an application thereon that communicates with the rolling area component 101 and/or the computing system 104. Such application may be an application dedicated to the rolling area component 101 and/or the computing system 106, a browser, or other suitable application. Such application may include a graphical user interface (GUI) depicting one or more fields for user input to control operation of the rolling area component 101 and/or the computing system 106. The GUI may further depict the data from the object value determination system 122.

Subsequent to determining that the user has rolled one or more die and the object value determination system 122 determining respective face indicators of the rolled die, the computing system 104 may be configured to determine that the user intends to make a second roll by removing the die from the rollable surface 108. If the object detection system 120 determines that no rollable objects have been placed on the rolling surface 108 for a threshold period of time, the computing system 104 then determines that the next placement of a rollable object on the rolling surface 108 comprises a new roll and the above described process performed by the object detection system 120, the object determination system 121, and/or the object value determination system 122 are performed again with respect to the new roll, e.g., new movement of the die/dice.

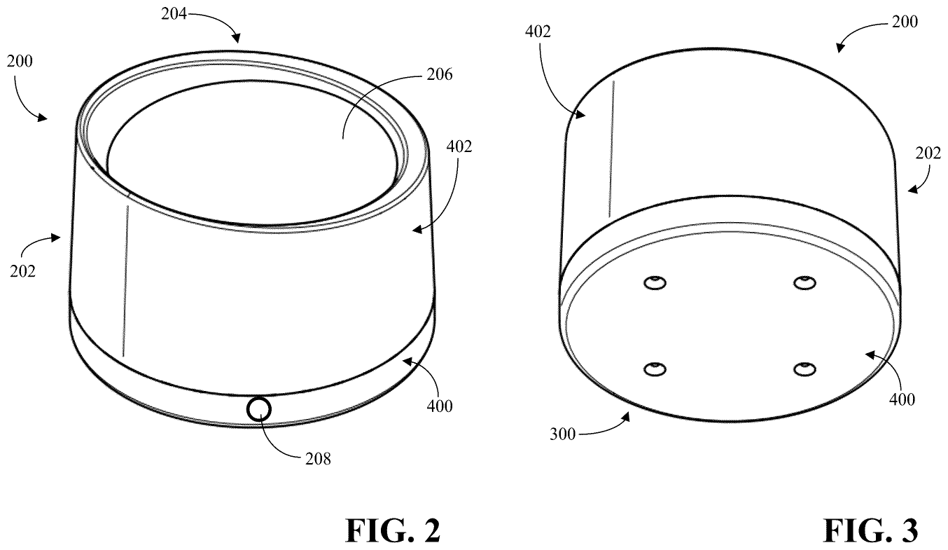

Turning now to FIGS. 2 and 3, an exemplary rolling area component 200 is shown. The rolling area component 200 includes a generally cylindrical housing 202 with an open top end 204. The rolling area component 200 further includes a rolling surface 206 for receiving rolling of the rollable object. The rolling surface 206 may be adjacent to and indented with respect to the top end 204 of the housing 202, as illustrated, or may be flush with the top end 204 of the housing 202. The top end 204 of the housing 202 may be angled such that a first amount of the housing 202 extends from a first edge portion of the rolling surface 206 while a second, smaller amount of the housing 202 extends from a second edge portion of the rolling surface 206. The increased height of the housing 202 at the first edge portion of the rolling surface 206 may act as a barrier wall to prevent the rolling die from unintentionally rolling out of the housing 202. The rolling surface 206 and the housing 202 may have similar cross-sections, as illustrated, and/or the cross-sections may vary.

Any suitable component may be employed for powering the rolling area component to operate the image capture device, illuminator, and/or the like. In one embodiment, the rolling area component relies on a user device connected by a power transfer cable (e.g., USB-C cable) to provide the necessary power to operate the rolling area component. In another embodiment, the rolling area component may include a cable with an interface attachable to an external power source, such as a wall power outlet. In a further embodiment, the rolling area component may include one or more internal power sources for powering the rolling area component. The internal power sources may include a capacitor, a battery, a rechargeable battery, and/or the like. Combination of the different power sources described above is also considered herein.

Furthermore, the rolling area component 200 may include a user interface for powering the rolling area component 200 on and off. Any suitable user interface is envisioned and, in the illustrated embodiment, the user interface comprises a button 208. In another embodiment, the user interface is a slidable tab, a rotatable knob, toggle switch, and/or the like. Additionally, or alternatively, the rolling area component may be configured to power off after a threshold amount of time without a new roll.

The rolling area component 200 may further include one or more engagement portions configured to limit unintentional sliding of the rolling area component 200. For instance, the engagement portion may include a bottom surface 300 of the rolling area component 200. In an example, the bottom surface 300 of the rolling area component 200 is formed of a material that results in a high coefficient of friction with a table surface to frictionally engage the table surface. In another example, the bottom surface 300 of the rolling area component 200 may include one or more ridges to selectively engage the table surface. In yet another example, the bottom surface 300 may include one or more protrusions that protrude from the bottom surface 300 made of material that results in a high coefficient of friction with a surface on which the rolling area component 200 is positioned, e.g., a table surface, floor, or other such article.

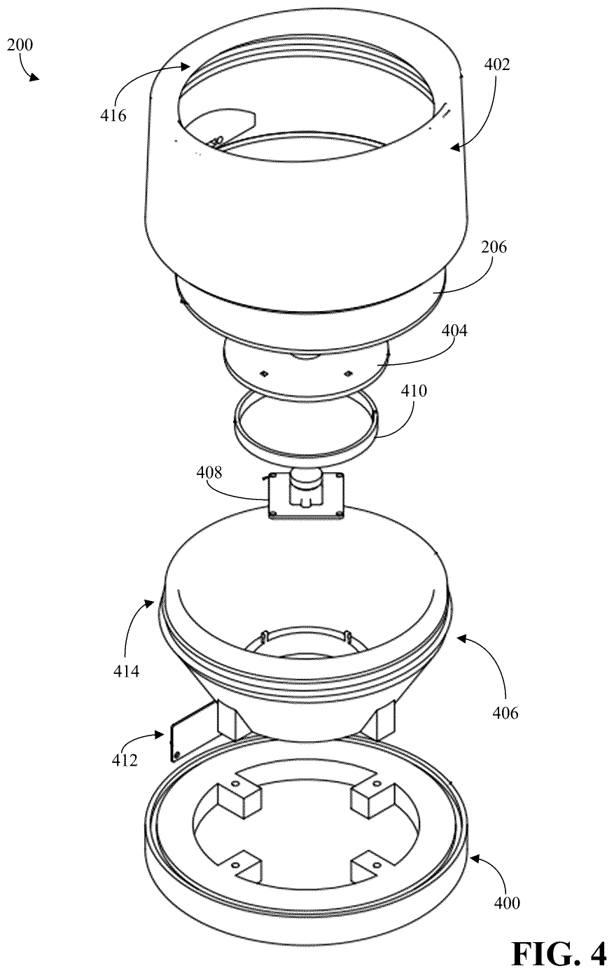

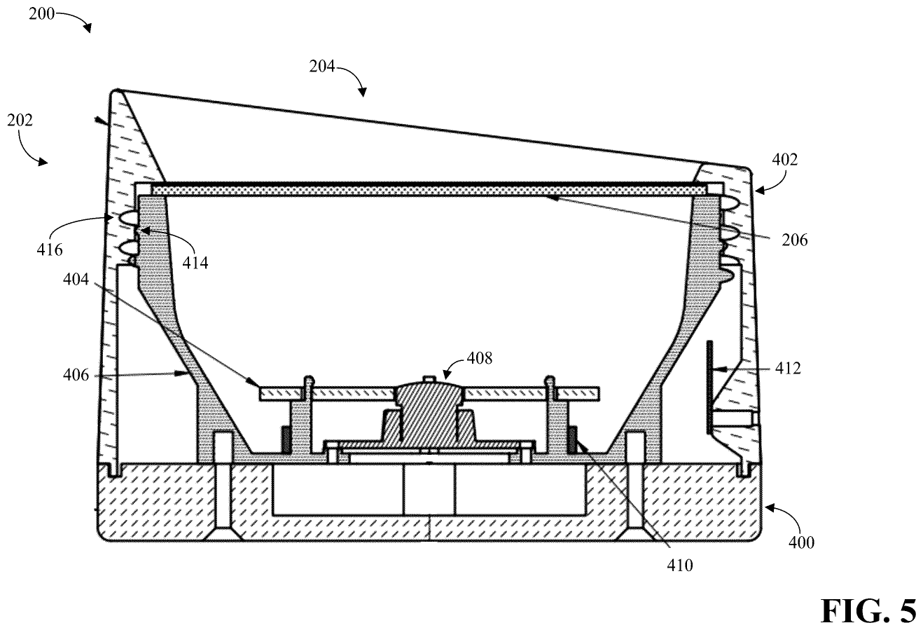

Turning now to FIG. 4, an exploded view of the rolling area component 200 is shown to illustrate one or more elements of the rolling area component 200. FIG. 5 shows a cross-sectional view of the assembled rolling area component 200 including the illustrated elements from FIG. 4. The housing 202 may be formed of multiple elements attached together and/or as a unitary component. In the illustrated embodiment, the housing 202 includes a base 400 and a separate outer shell 402 that are attached to one another in a final assembly. In addition to the rolling surface 206, the rolling area component 200 includes a light baffle 404, a light cone 406, a camera board 408, a light emitting diode (LED) light ring 410, a Universal Serial Board (USB) out connector and controller board 412, or a combination thereof.

The different elements of the rolling area component 200 may be formed of any suitable material and different elements may be formed of different material. For instance, the elements of the housing 202 (e.g., the base 400 and/or the outer shell 402) may be formed of plastic resin, metal alloys, wood, glass, acrylic polymers, acrylic resin, etc. As another example, the rolling surface 206 may be formed of plastic resin, glass, etc. The material of the rolling surface 206 may be further selected to be scratch resistant to prevent undesired degradation of the top surface of the rolling surface 206 during use. Additionally, or alternatively, in one embodiment, the rolling surface 206 may include a replaceable layer on the top surface of the rolling surface 206 that may be removed after becoming scratched to limit scratches on the top surface of the rolling surface 206.

The base 400 may enclose and conceal one or more electronic components of the rolling area component 200 to protect the electronic component. Additionally, the base 400 may provide a foundation for anchoring or supporting the rolling area component 200 for assembling the rolling area component 200. Additionally, the base 400 may be weighted to provide an anchor the rolling area component 200 to inhibit unnecessary and/or undesirable movement of the rolling area component 200 during operation or use.

The light cone 406 can take any suitable shape, and in the illustrated embodiment the light cone 406 comprises walls in a truncated conical form. The truncated conical form includes a wider top near the rolling surface 206 in the assembled state and a narrower portion near the base 400 in the assembled state. The light cone 406 may be attached to the housing 202 or a component thereof to secure the light cone 406 within the housing. In an exemplary embodiment, the light cone 406 includes threads 414 that engage corresponding threads 416 in the outer shell 402. In another embodiment, the light cone 406 is attached to the housing 202 by a push lock, a clip, an adhesive, a spring loading, and/or the like.

The angling of the walls of the light cone 406 to define the wide top and narrow bottom provides a reflective surface that both diffuses and redirects light toward the rolling surface 206. The walls of the light cone 406 may also define a mounting surface for the camera board 408 at a fixed distance from the rolling surface 206, thereby providing a consistent focal point to promote reliable and consistent results for users.

In the illustrated embodiments, the second side of the rolling surface 206 is illuminated by the combination of the light cone 406 and the LED light ring 410 arranged to illuminate parallel to the rolling surface 206, however other arrangements and/or illuminators are envisioned. For instance, the second side of the rolling surface 206 may be illuminated with edge-lighting. In another example, the second side of the rolling surface 206 may be illuminated with collimated light.

The camera board 408 may include a lens (e.g., a fisheye lens, etc.) seated on the light cone 406 and may be mounted concentrically within the light baffle 404. The camera board 408 may be positioned to capture at least a portion of the bottom surface of the rolling surface 206. In one embodiment, the camera board 408 is positioned to capture the entire bottom surface of the rolling surface 206. By positioning the rolling surface 206 at the end of the light cone 406, the light cone 406 ensures that the rolling surface 206 and the camera board 408 may be held at a fixed distance. Images captured by the camera board 408 may then be transmitted to other devices (e.g., the computing system 104, the user device 106) via the controller board 412. Collection, transmission, and/or storage or retention of the images enables continuous flow of the game, verification of results, and review/assurance for validation as might be necessary.

In the illustrated embodiment, a single camera board 408 with a single lens is illustrated. However, any suitable number of cameras and/or lens are envisioned. For instance, multiple cameras may be employed and the multiple cameras may be collated. In such an embodiment, images captured by the multiple cameras may be combined into a single image, or a sequence of single images. In one embodiment, the multiple cameras may be organized on a single plane. In another embodiment, the multiple cameras may be organized on multiple planes.

The light baffle 404 may be a cylindrical bobbin that seats around the lens of the camera board 408 and over a light source. The light source may be positioned within the light baffle 404 so as to emit light radially into the side of the light cone 406. The emitted light may be used to illuminate the underside of the rollable object without introducing unnecessary glare on the rolling surface 206. For instance, the emitted light encounters the interior wall(s) of the light cone 406, where the emitted light is diffused and redirected from the base and the narrow bottom to the rolling surface 206 above. By illuminating the rolling surface 206 in this manner, the camera/camera board 408 may be better enabled to accurately and quickly capture the underside image that is evaluated and determined for transmission to a user.

As noted above, the rolling surface may take any suitable shape, configuration, material, and/or the like. For instance, the rolling surface 206 may be formed of a frosted material. The frosted material may encourage blurring of irrelevant objects in the image that are not in contact with the frosted surface 206, thereby reducing the errors that might be caused by irrelevant objects, uneven surface features, poor lighting, and/or combinations thereof.

In the above embodiments, the image capture device 112 is positioned to directly capture the bottom surface of the rolling surface 108. However, establishing a fixed distance between the bottom surface of the rolling surface 108 and a corresponding lens of the image capture device 112 to fully capture the bottom surface may result in a large rolling area component 101. Accordingly, the rolling area component 101 may include a reflective surface positioned below the rolling surface 108 and the image capture device 112 is configured to capture an image of the reflective surface, and by extension the reflected bottom surface of the rolling surface 108.

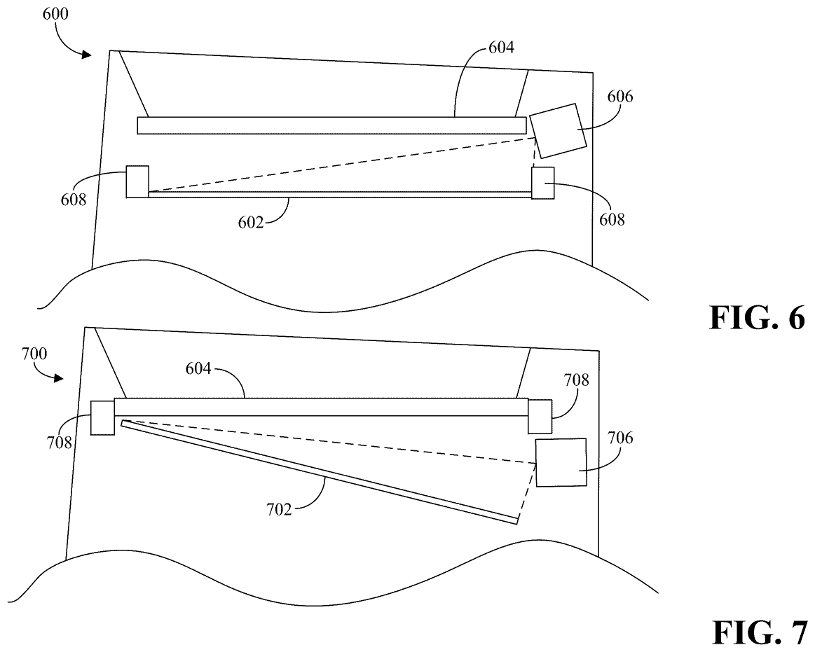

FIGS. 6 and 7 show two different embodiments of this example. As shown in FIG. 6, in one embodiment a rolling area component 600 includes a reflective surface 602 with a reflective side arranged in parallel to the rolling surface 604. The rolling area component 600 includes an image capture device 606 positioned to capture the reflective side of the reflective surface 602. The rolling area component 600 may further include an illuminator 608 positioned to illuminate the rolling surface 604 and/or the reflective surface 602.

In another embodiment shown in FIG. 7, a rolling area component 700 may include a reflective surface 702 with a reflective side arranged at an angle with respect to a rolling surface 704. The rolling area component 700 may further include an image capture device 706 positioned to capture the reflective side of the reflective surface 702. As seen in FIG. 7, the image capture device 706 and the reflective surface 702 may be oriented such that a lens of the image capture device 706 is perpendicular to the rolling surface 704. The rolling area component 700 may further include an illuminator 708 positioned to illuminate the rolling surface 604 and/or the reflective surface 702.

As noted above, a die map may be employed by the object value determination system 122 to determine a face indicator on a first side of a die based on a face indicator on a second side of the die. FIG. 8 illustrates an exemplary embodiment of a die map 800 for a six-sided die where each side of the die has a square face. Accordingly, the die map 800 includes six separate square faces 802-812 where each square face includes a representation of a face indicator that would be captured by the image capture device when the face rests on the rolling surface. The object value determination system 122 then uses the respective positions of squares within the die map 800 to determine which face indicators are on opposing sides of a three-dimensional die. For instance, in a 3-dimensional representation of the die map 800, square face 802 is opposite square face 806, square face 804 is opposite square face 808, and square face 810 is opposite square face 812.

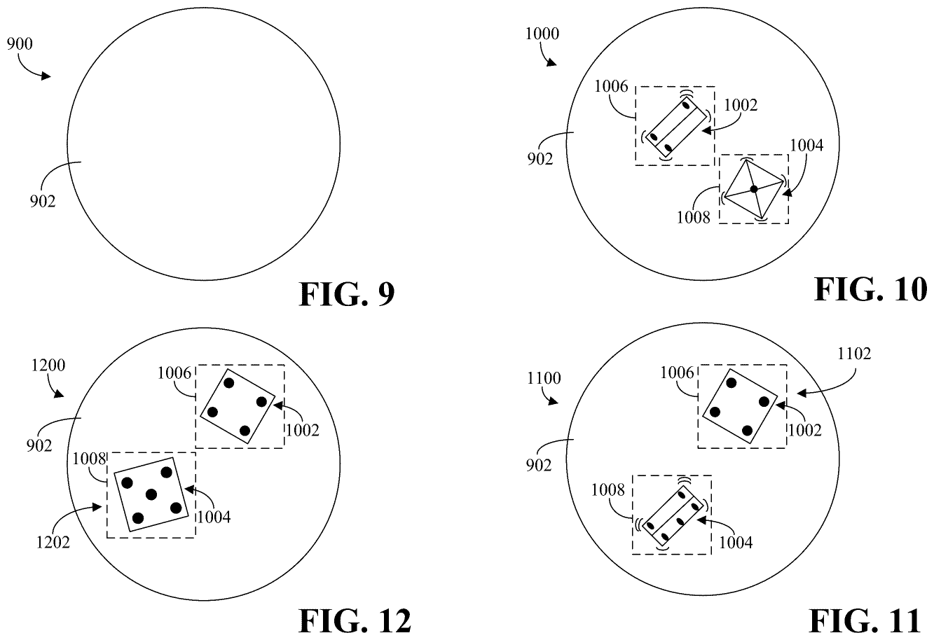

Turning now to FIGS. 9-12, illustrated is an example of different images during a video monitored by the object detection system 120 used to determine that a roll has taken place. In a first image 900 in FIG. 9, no rollable objects are present on a rolling surface 902. In a second image 1000 illustrated in FIG. 10, the object detection system 120 determines that two rollable objects (e.g., die) 1002 and 1004 are present on the rolling surface 902 and two bounding boxes 1006 and 1008 are generated with a bounding box for each die. In the illustrated embodiment, the bounding boxes 1006 and 1008 are oriented with respect to an X-axis, although oriented bounding boxes where the bounding box is aligned with an axis of the rollable object are envisioned.

In a third image 1100 illustrated in FIG. 11, the first die 1002 has stopped rolling with a face resting on the rolling surface 902 at position 1102 on the rolling surface 902. In contrast, the second die 1004 continues rolling as indicated by the moving respective second bounding box 1008.

In a fourth image 1200 illustrated in FIG. 12, the second die 1004 has similarly stopped rolling with a face resting on the rolling surface 902 at position 1202 on the rolling surface 902 while the first die 1002 stayed in position 1102.

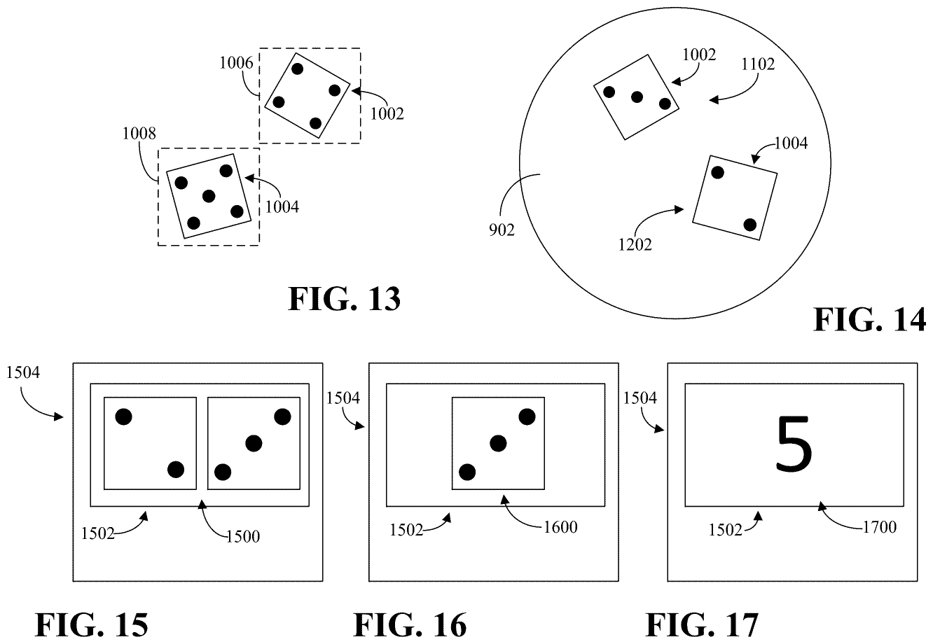

Subsequent to determining that both bounding boxes 1006 and 1008 have not moved beyond a threshold amount, the object detection system 120 may then crop the image captured in FIG. 12 for use by the object determination system 121 and/or the object value determination system 122, as seen in FIG. 13. The object value determination system 122 then determines a respective face indicator for each of the two dice 1002 and 1004, that would correspond to a top-down view of the rolling surface 902 as shown in FIG. 14.

As described above, the computing system 104 and/or the user device 106 may be configured to cause different depictions of the determined face indicators from the object value determination system 122. For instance, a user may request a visual representation of top image face of a die, a number representing the sum of the determined face indicators of the top image faces of the rolled dice, a number representing the largest or smallest numerical value of the determined face indicator of the top image faces of the rolled dice, and/or the like. Illustrated in FIGS. 15-17 are different displays of a user device with different visual representations of the determined face indicators illustrated in FIG. 14.

For instance, in FIG. 15, the visual representation 1500 in a display 1502 of a user device 1504 comprises top image faces of die one 1002 and die two 1004. In the example shown in FIG. 16, a visual representation 1600 in the display 1502 comprises only a top image face of the die with the largest numerical value of the determined face indicator. In a further example shown in FIG. 17, a visual representation 1700 in the display 1502 comprises a numerical value representing a sum of the determined face indicators of the top image faces of the rolled dice.

In the embodiments described above, the rolling surface (e.g., rolling surface 108) is substantially planar, however it is conceivable that the rolling surface may have one or more etchings formed on the top surface and/or the bottom surface. For instance, the etchings may include one or more symbols, characters, icons, and/or the like that are independent of determining the face indicator. In another example, the etchings may include one or more symbols, characters, icons, and/or the like and interaction between the rollable object and the etching (e.g., a rolled position of a die is within an etched circle on the top surface) results in the object value determination system applying an etching factor. For instance, the object value determination system may apply a multiplier to the value of the face indicator determined by the object value determination system.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art may recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In reference to the disclosure herein, for purposes of convenience and clarity only, directional terms, such as, top, bottom, left, right, up, down, upper, lower, over, above, below, beneath, rear, and front, may be used. Such directional terms should not be construed to limit the scope of the features described herein in any manner. It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the features described herein.

Moreover, the term “or” is intended to mean an inclusive “or” rather than an exclusive “or. ” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

What is claimed:

1. A rollable object outcome reader comprising:
a rolling surface that supports on a first side of the rolling surface one or more rollable objects each including a plurality of surfaces that each include a respective face indicator;
an image capture device configured to capture an image of a second side of the rolling surface opposite the first side; and
a control system configured to:
receive the captured image from the image capture device;
determine an orientation of a rollable object on the first side of the rolling surface based on the captured image, wherein determining the orientation includes determining a first face indicator of a first surface of the rollable object resting on and directly facing the first side of the rolling surface; and
determine a second face indicator of a second surface of the rollable object opposite the first surface based on the determined first face indicator of the first surface, wherein determining the second face indicator is based on a predetermined relationship for the rollable object.

2. The rollable object outcome reader of claim 1, wherein the rolling surface is translucent.

3. The rollable object outcome reader of claim 1, wherein the image capture device comprises a camera.

4. The rollable object outcome reader of claim 1, further comprising a light source positioned to illuminate the second side of the rolling surface.

5. The rollable object outcome reader of claim 4, further comprising a light cone positioned to reflect light from the light source toward the second side of the rolling surface.

6. The rollable object outcome reader of claim 1, wherein a lens of the image capture device is positioned to face the second side of the rolling surface.

7. The rollable object outcome reader of claim 1, further comprising a reflective surface arranged to reflect the second side of the rolling surface, wherein a lens of the image capture device is positioned to capture the image of the second side of the rolling surface by capturing an image of the reflective surface.

8. The rollable object outcome reader of claim 7, wherein the reflective surface extends parallel to the second side of the rolling surface.

9. The rollable object outcome reader of claim 7, wherein the lens of the image capture device is positioned perpendicular to the rolling surface.

10. The rollable object outcome reader of claim 1, wherein the control system is further configured to:
generate a bounding box around the rollable object that moves with the rollable object; and
determine movement of the rollable object by detecting movement of the bounding box.

11. The rollable object outcome reader of claim 10, wherein the control system is further configured to operate the image capture device to capture the image after detecting that the bounding box remains stationary for a predefined threshold of time.

12. The rollable object outcome reader of claim 1, further comprising a housing, wherein the rolling surface and the image capture device are retained in the housing such that the image capture device is a fixed distance from the rolling surface.

13. The rollable object outcome reader of claim 12, further comprising:
a light source positioned to illuminate the second side of the rolling surface; and
a light cone positioned to reflect light from the light source toward the second side of the rolling surface,
wherein the light source and the light cone are arranged in the housing between the rolling surface and the image capture device.

14. The rollable object outcome reader of claim 13, wherein the light cone includes threads that engage corresponding housing threads to attach the light cone to the housing.

15. The rollable object outcome reader of claim 1, wherein the control system is further configured to:
determine a second orientation of a second rollable object on the first side of the rolling surface based on the captured image, wherein determining the second orientation includes determining a third face indicator of a third surface of the second rollable object resting on and directly facing the first side of the rolling surface; and
determine a fourth face indicator of a fourth surface of the second rollable object opposite the third surface based on the determined third face indicator of the third surface, wherein determining the fourth face indicator is based on a predetermined relationship for the second rolling object.

16. A method of determining an outcome of rolling a rollable object comprising:
capturing an image of a second side of a rolling surface opposite a first side of the rolling surface that supports the rollable object, wherein the rollable object includes a plurality of surfaces that each include a respective face indicator;
determining an orientation of a rollable object on the first side of the rolling surface based on the captured image by determining a first face indicator of a first surface of the rollable object resting on and directly facing the first side of the rolling surface; and
determining a second face indicator of a second surface of the rollable object opposite the first surface based on the determined first face indicator of the first surface and a predetermined relationship for the rolling object.

17. The method of claim 16, wherein the step of capturing the image includes:
generating a bounding box around the rollable object that moves with the rollable object;
determining movement of the rollable object by detecting movement of the bounding box; and
capturing the image after detecting that the bounding box remains stationary for a predefined threshold of time.

18. The method of claim 16, further comprising detecting that the rollable object has been removed from the rolling surface; and
detecting that a second rollable object is placed on the first side of the rolling surface.

19. The method of claim 18, further comprising capturing a second image of the second side of the rolling surface after detecting that the second rollable object is placed on the first side of the rolling surface after detecting an absence of a rollable object for a threshold period of time.

20. A non-transitory computer-readable medium storing instructions that, when executed by a control system of a rollable object outcome reader, cause the control system to:
receive an image captured by an image capture device of a second side of a rolling surface while one or more rollable objects are supported on a first side of the rolling surface, wherein the first side is opposite the second side;
determine an orientation of a rollable object on the first side of the rolling surface based on the captured image, wherein determining the orientation includes determining a first face indicator of a first surface of the rollable object resting on and directly facing the first side of the rolling surface; and
determine a second face indicator of a second surface of the rollable object opposite the first surface based on the determined first face indicator of the first surface, wherein determining the second face indicator is based on a predetermined relationship for the rolling object.
